(19) United States
(12) Patent Application Publication
(10) Pub. No.: US 2012/0092634 A1
(43) Pub. Date: Apr. 19, 2012

(54) Method and apparatus for printing periodic patterns

(76) Inventors: Harun H. Solak, Brugg (CH); Francis S. M. Clube, Neuchatel (CH); Christian Dais, Turgi (CH)

(21) Appl. No.: 12/903,389

(22) Filed: Oct. 13, 2010

(51) Int. Cl. G03B 27/54

(52) U.S. Cl. 355/67; 355/77

(57) ABSTRACT

A method for printing a pattern of features including the steps of providing a substrate having a recording layer disposed thereon, providing a mask bearing a periodic pattern of features, arranging the substrate parallel to the mask and with a separation having an initial value, providing an illumination system for illuminating the mask with an intensity of monochromatic light to generate a transmitted light-field for exposing the recording layer, and illuminating the mask for an exposure time whilst changing the separation by a range having a predetermined value and varying at least one of the rate of change of separation and the intensity of illumination so that the mask is illuminated by an energy density per incremental change of separation that varies over said range, whereby the printed pattern has low sensitivity to a deviation of the range from said predetermined value or to the initial value of the separation.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION BY REFERENCE OF MATERIAL SUBMITTED ON A COMPACT DISC

Not Applicable

### BACKGROUND TO THE INVENTION

1. Field of the invention

This invention relates generally to the field of photolithography as employed for the fabrication of micro- and nano-structures, and it relates particularly to the field of photolithography based on the Talbot effect.

2. Description of Related Art

Lithographic fabrication enables the formation of micro- and nano-patterns on surfaces. Photolithographic techniques achieve this by exposing a photosensitive surface to a light-field with an intensity distribution corresponding to the desired pattern. The photosensitive surface is usually a thin layer of a sensitive material, such as photoresist, which is coated either directly on a substrate surface or indirectly over intermediate layers of other materials. Chemical or physical changes that occur in the photosensitive layer as a result of the exposure are used in subsequent processes to obtain a desired pattern in the material of the substrate or in an intermediate layer of another material. In the most commonly used photolithographic technique an image of a pattern defined in a mask is projected onto the substrate surface using an optical system.

For many applications patterns are required that comprise a unit cell of pattern features that repeat in one or two dimensions, that is, periodic patterns. A specialized photolithographic technique for transferring such patterns from masks onto substrates is based on the Talbot effect. When a periodic pattern defined in a mask is illuminated with a collimated beam of monochromatic light, diffraction orders in the transmitted light-field reconstruct “self-images” of the pattern at regular distances from the mask in so-called Talbot planes. The separation of the self-images, S, which is known as the Talbot distance, is related to the illumination wavelength, λ, and period of the pattern, p, by

S≈2p²/λ equ. (1)

Whereas, this formula has good accuracy when p>>λ (i.e. when the light is diffracted at relatively small angles), it approximates less well as the magnitude of p approaches λ. Locating a photoresist-coated substrate at one of these planes results in the mask pattern being printed into the photoresist (see, for example, C. Zanke, et al., “Large area patterning for photonic crystals via coherent diffraction lithography”, J. Vac. Sci. Technol. B 22, 3352 (2004)). Furthermore, at intermediate distances between the self-image planes, Talbot sub-images are formed that have higher spatial frequencies than the pattern in the mask, which may be printed by placing a photoresist-coated substrate at one of these fractional Talbot planes. The printed results achieved using these techniques are improved when the duty cycle of the mask pattern (i.e. the dimension of the features as a fraction of the feature period) is selected to produce a high contrast of intensity distribution in the Talbot or fractional Talbot plane (see U.S. Pat. No. 4,360,586). It is also known in the prior art that the contrast of the Talbot images can be further enhanced by fabricating the periodic patterns in the mask using phase shifting materials. Photolithography using Talbot imaging is especially advantageous for printing high-resolution periodic patterns in view of the high cost of conventional, projection-type photolithographic systems for such patterns.

A major shortcoming of the Talbot technique, however, is that the intensity distributions of the self-images and sub-images are very sensitive to the distance from the mask, that is, they have a very narrow depth of field. This means that the substrate needs to be positioned very accurately with respect to the mask in order to correctly print the grating. This becomes increasingly more difficult as the grating period is reduced because the depths of field of the self-images and sub-images depend on the square of the pattern period. Furthermore, if the pattern needs to be printed onto a substrate surface that is not very flat or if there are topographical structures on its surface, or the pattern needs to be printed into a thick layer of photoresist, it may be impossible to achieve the desired result.

Achromatic Talbot lithography has recently been introduced as a new method for printing high-resolution periodic patterns in a cost effective way (see H. H. Solak, et al., “Achromatic Spatial Frequency Multiplication: A Method for Production of Nanometer-Scale Periodic Structures”, J. Vac. Sci. Technol., 23, pp. 2705-2710 (2005), and U.S. Pat. Appl. no. 2008/0186579). It offers two significant advantages for lithographic applications: firstly, it overcomes the depth-of-field problem encountered using the classical Talbot method; and, secondly, for many pattern types it performs a spatial-frequency multiplication, that is, it increases the resolution of the printed features with respect to that of the pattern in the mask. In achromatic Talbot lithography (ATL) the mask is illuminated with a collimated beam from a light source with a broad spectral bandwidth, and beyond a certain distance from the mask the transmitted light-field forms a so-called stationary image whose intensity distribution is invariant to further increase in distance. The minimum distance, dₘᵢₙ, from the mask at which this occurs is related to the period of the pattern, p, in the mask and to the spectral bandwidth of the illumination, Δλ, by:

dₘᵢₙ≈2p²/Δλ equ. (2)

Beyond this distance, the Talbot image planes for the different wavelengths are distributed in a continuous manner with increasing distance from the mask, which generates the stationary image. Thus, by placing a photoresist-coated substrate in this region exposes the substrate to the entire range of transverse intensity distributions formed between successive Talbot planes for a particular wavelength. The pattern printed onto the substrate is therefore an average, or integration, of this range of transversal intensity distributions, which is substantially insensitive to longitudinal displacement of the substrate with respect to the mask. The technique therefore enables a much larger depth of field than with standard Talbot imaging, and a much larger depth of field than with conventional projection, proximity or contact printing.

The intensity distribution in an ATL image from a particular mask pattern may be determined using modeling software that simulates the propagation of electromagnetic waves through and after the mask. Such simulation tools may be used to optimize the design of the pattern in the mask for obtaining a particular printed pattern at the substrate surface.

The ATL method has been developed primarily to print periodic patterns that comprise a unit cell that repeats with a constant period in at least one direction. The technique may, however, also be successfully applied to patterns whose period spatially varies in a sufficiently “slow”, gradual way across the mask such that the diffraction orders that form a particular part of the stationary image are generated by a part of the mask in which the period is substantially constant. Such patterns may be described as being quasi-periodic.

A drawback of ATL is that it requires a light source with a significant spectral bandwidth in order that the separation required between the mask and substrate is not disadvantageously large. The angular divergence of the different diffracted orders propagating from the mask produces spatial offsets between the different orders at the substrate surface resulting in imperfect image reconstruction at the pattern edges, which becomes worse with increasing separation. Fresnel diffraction at the edges of the diffracted orders also degrades the edges of the printed pattern, and this likewise gets worse with increasing separation. For these reasons laser sources, which have relatively small spectral bandwidth, are in most cases unsuitable for ATL.

A difficulty with applying non-laser sources such as arc lamps or light emitting diodes to ATL is obtaining the combination of high power in the exposure beam (for ensuring high throughput in a production process) and good beam collimation (for ensuring high-contrast imaging and minimizing loss of feature resolution). Obtaining good collimation from these sources requires spatial filtering of the output beam which generally results in a large loss of power.

The advantages of the ATL technique may be obtained using a different but related technique that is disclosed in U.S. Pat. Appl. no. 2008/0186579. In this scheme, the periodic pattern in the mask is illuminated by a collimated beam of monochromatic light and during exposure the distance of the substrate from the mask is varied over a range corresponding to an integer multiple of the separation between successive Talbot image planes in order that an average of the intensity distributions between Talbot planes is printed on the substrate. The smallest displacement that may be employed is therefore equal to the separation of successive Talbot planes (when integer=1). With this displacement during exposure, the pattern printed on the substrate is substantially the same as that printed using the ATL technique. It is disclosed that the displacement may be performed either continuously or in a discrete way by exposing the substrate at multiple discrete positions over the range. Using the continuous displacement, the speed of displacement is necessarily constant in order that the desired average of the transversal intensity distributions is obtained, and using the discrete, or stepped, displacement, the exposure dose at each discrete position should necessarily be the same for the same reason. The general technique may be referred to as displacement Talbot lithography (DTL)

Whereas the integrated intensity distributions generated at the substrate using the ATL and DTL techniques are essentially equivalent, and both enable a large depth of field and spatial-frequency multiplication for the printed pattern, the DTL scheme has the advantage that it can be used with much smaller separations of the substrate and mask. This reduces the degradation of the pattern edges and allows more efficient utilization of the output from the light source because of the less stringent requirement on collimation. Further, the DTL technique enables the use of laser sources, which may be preferred for production processes. The light from such sources can be formed into well-collimated beams with negligible loss of power, so minimize loss of feature resolution and maximize image contrast.

The structure of the patterns printed using DTL from a particular mask pattern may also be theoretically determined using simulation software.

The prior art further mentions that DTL, like ATL, may be applied to quasi-periodic patterns, though the details, limitations and disadvantages of this are not disclosed.

A drawback of the DTL technique is that the longitudinal displacement of the substrate relative to the mask during exposure has to correspond accurately to an integer multiple of the Talbot distance. When the displacement is exactly an integer multiple, the integrated intensity distribution exposing the substrate is independent of the initial separation of the substrate and mask, and so produces a uniform exposure of the pattern features on the substrate even if the mask and substrate are not accurately flat and parallel. If, on the other hand, the displacement is not an exact integer multiple of the Talbot distance because of, for example, mechanical hysteresis or limited stepping resolution of a displacement actuator, or because of inexact synchronization between the duration of the exposure by the illumination system and the displacement of the substrate, then the integrated intensity distribution depends on the initial separation. In this case, if the mask and substrate are not accurately flat and parallel, then a spatial variation of feature size is introduced into the printed pattern; or, if the mask and substrate are accurately flat and parallel but their separation is different for different substrates, then the size of the printed features varies from substrate to substrate; both of which may be problems for certain applications. These variations of feature size may be reduced by longitudinally displacing the substrate by a large number of Talbot distances relative to the mask, but this can introduce other problems such as degradation of the feature resolution (if the illumination beam is not well collimated), distortion of the feature shape (if the direction of displacement is not accurately longitudinal), degradation of the pattern edges (if the gap becomes too large), and disadvantageously requires larger travel range in the mechanical system.

A further difficulty in arranging that the longitudinal displacement corresponds accurately to an integer multiple of the Talbot distance is that in the general case the transmitted light-field is not exactly periodic in the direction orthogonal to the mask, as is explained for two particular examples of one-dimensional and two-dimensional patterns below. In the case of a one-dimensional periodic pattern, i.e. a linear grating, if the grating period in relation to the illumination wavelength is such that only 0^{th} and 1^{st} diffraction orders propagate in the transmitted light-field, then the resultant interference pattern is exactly periodic in the direction orthogonal to the mask (neglecting effects at the edges of the mask pattern), and the self-image planes are well defined and separated by an exact Talbot distance. If, however, the period of the grating in relation to the wavelength is such that 2^{nd} and possibly higher diffraction orders also propagate, then the phases of the higher orders at the self-image planes (as defined by the 0^{th} and 1^{st} orders) are not exactly the same as at the output plane of the mask, and so self-images are not accurately formed and the transmitted light-field is not periodic in the direction orthogonal to the mask. With higher diffraction orders propagating it is therefore impossible with the prior art teaching of DTL to avoid some dependence of the integrated intensity distribution on the initial value of the separation between the substrate and mask, which makes it difficult to print a pattern uniformly and reproducibly. In the case of a two-dimensional periodic pattern, there are further considerations for obtaining an exactly periodic light-field in the direction orthogonal to the mask. For example, even if there are only 0^{th} and 1^{st} orders in the transmitted light-field, if the periods of the pattern components in the different directions are not the same, then the Talbot distances relating to the different components must also be different, and so the transmitted light-field cannot be periodic in the direction orthogonal to the mask. In a further example, even if the pattern features are arranged on a square grid (so that the periods in the pattern components in the two directions are the same), if diffraction orders propagate from the mask in planes of diffraction at 45° to the grating vectors of the mask pattern, then these “diagonally diffracted” orders also cause a non-periodic light-field in the direction orthogonal to the mask.

Yet another difficulty with the prior art teaching of displacement Talbot lithography is its application to quasi-periodic patterns whose period is not uniform but varies slowly over the pattern area or to mask patterns containing a plurality of discrete grating periods. With such patterns, it is not possible to illuminate the complete pattern and displace the substrate relative to the mask by an exact integer multiple of the Talbot distance that simultaneously satisfies the different periods; and therefore, for reasons explained earlier, it is not possible to print such patterns uniformly.

It is therefore a first object of the present invention to provide a method and apparatus related to displacement Talbot lithography for printing a periodic pattern of features uniformly and reproducibly onto a substrate from a pattern in a mask without requiring the substrate to be displaced relative to the mask by a distance that corresponds accurately to an integer multiple of the Talbot distance.

It is a second object of the present invention to provide a method and apparatus related to displacement Talbot lithography for printing a periodic pattern of features uniformly and reproducibly onto a substrate from a pattern in a mask without requiring a displacement of the substrate with respect to the mask that corresponds to a large multiple of the Talbot distance, especially for the purpose of maximizing the resolution of the printed features, minimizing distortion of the shapes of the printed features, and minimizing degradation of the pattern edges.

It is a third object of the present invention to provide a method and apparatus related to displacement Talbot lithography for printing a one-dimensional periodic pattern of features uniformly and reproducibly onto a substrate from a one-dimensional mask pattern whose period in relation to the wavelength of illumination is such that 2^{nd} or higher diffraction orders are generated in the light-field transmitted by the mask.

It is a fourth object of the present invention to provide a method and apparatus related to displacement Talbot lithography for printing a two-dimensional periodic pattern of features uniformly and reproducibly onto a substrate from a two-dimensional mask pattern whose periods in the different directions are not the same or which generates diagonally diffracted orders.

It is a fifth object of the present invention to provide a method and apparatus related to displacement Talbot lithography for printing a periodic pattern of features uniformly and reproducibly onto a substrate from a mask pattern whose period varies either continuously or step-wise across the mask.

It is a sixth object of the present invention to provide a method and apparatus related to displacement Talbot lithography for printing a periodic pattern of features uniformly and reproducibly onto a substrate from a mask pattern that does not require an exact synchronization between the exposure by the illumination system and the displacement of the substrate or mask.

### SUMMARY OF THE INVENTION

According to a first aspect of the present invention, a method is provided for printing at least one of a first periodic pattern of features and a first quasi-periodic pattern of features, which includes the steps of:

a) providing a substrate having a recording layer disposed thereon;

b) providing a mask bearing at least one of a second periodic pattern of features and a second quasi-periodic pattern of features;

c) arranging the substrate substantially parallel to the mask and with a separation having an initial value;

d) providing an illumination system for illuminating the mask with an intensity of substantially monochromatic light to generate a transmitted light-field for exposing the recording layer; and

e) illuminating the mask for an exposure time whilst changing the separation by a range having a predetermined value and varying at least one of the rate of change of separation and the intensity of illumination so that the mask is illuminated by an energy density per incremental change of separation that varies over said range, whereby the printed pattern has low sensitivity to a deviation of the range from said predetermined value or to the initial value of the separation.

Advantageously, the variation of energy density per incremental change of separation over the range corresponds substantially to one of a truncated Gaussian distribution, a truncated sinusoidal distribution, or a triangular distribution, though other variations that approximate to those distributions may also be employed.

Preferably, the change of separation of the substrate and mask over which the energy density per incremental change of separation is varied corresponds substantially to an even multiple of the Talbot distance separating the Talbot planes in the light-field transmitted by the illuminated mask, and most preferably it corresponds substantially to twice the Talbot distance.

Preferably, the full-width at half-maximum of the variation of the energy density per incremental change of separation over the range corresponds substantially to a multiple of the Talbot distance, and most preferably it corresponds to the Talbot distance.

Advantageously, the separation of the mask and wafer is changed in a continuous manner over the range, although it may alternatively be changed in a discrete manner by changing the separation in a series of smaller steps over the range, wherein the separation remains constant for the same or different periods of time after each step.

Advantageously, especially when employing a scanning exposure beam, the separation may be changed a plurality of times over the range, wherein at least one of the rate of change of separation and the intensity of illumination are varied during each of said changes of separation.

According to a second aspect of the present invention, an apparatus is provided for printing at least one of a first periodic pattern of features and a first quasi-periodic pattern of features, which includes:

a) a substrate having a recording layer disposed thereon;

b) a mask bearing at least one of a second periodic pattern of features and a second quasi-periodic pattern of features;

c) a means for arranging the substrate substantially parallel to the mask and with a separation having an initial value;

d) an illumination system for illuminating the mask with an intensity of substantially monochromatic light to generate a transmitted light-field for exposing the recording layer;

e) a means for changing the separation over a range having a predetermined value during the illumination of the mask; and

f) a means for varying at least one of the rate of change of separation and the intensity of illumination so that the mask is illuminated by an energy density per incremental change of separation that varies over the range, whereby the printed pattern has low sensitivity to a deviation of the range from said predetermined value or to the initial value of the separation.

Preferably, the varying means either displaces an actuator with a variable speed or modulates the intensity of the light illuminating the mask.

In the latter case, the varying means advantageously comprises a variable attenuator included in the path of the illumination beam between the light source of the illumination system and the mask that modulates, most preferably under computer control, the intensity of the beam illuminating the mask. Alternatively, the intensity varying means modulates, most preferably under computer control, the electrical input to the light source such that the power of its output beam is varied.

Preferably, the features of the pattern in the mask comprise transparent spaces in a layer of an opaque material, such as chrome, formed on a transparent substrate. Alternatively, they may comprise transparent spaces in a layer of a transparent or partially transparent material that introduces a relative phase shift into the locally transmitted light, formed on a transparent substrate.

The periodic pattern or patterns in the mask and the printed pattern or patterns may either be one-dimensional patterns (i.e. linear gratings), or two-dimensional patterns (with features arranged on, for example, square, rectangular or hexagonal grids), or a mixture of one-dimensional and two-dimensional periodic patterns. In the case that there is a plurality of periodic patterns in the mask, the patterns may have the same period or may have different periods, and their grating vectors may be in the same direction or may be in different directions.

Advantageously, the illumination system generates an illumination beam that is uniform and which is stationary with respect to the mask during the exposure. Alternatively, the illumination system can scan a beam across the mask so that the time-integrated exposure density is uniform across the pattern. In this case the variation of energy density per incremental change of separation over the range of separation should be repeated with high frequency during the exposure such that each point of the mask pattern receives the same variation of energy density per incremental change of separation over the range of separation.

### BRIEF DESCRIPTION OF THE SEVERAL VIEWS OF THE DRAWINGS

The above and/or other aspects of the present invention will become apparent and more readily appreciated from some exemplary embodiments described below, taken in conjunction with the accompanying drawings, in which:

FIG. 1 is a schematic representation of a first embodiment of the invention for printing a periodic pattern onto a wafer by varying the speed of longitudinal displacement of the wafer with respect to a mask during an exposure of the mask.

FIG. 2 shows a computer simulation of the light-field transmitted after the mask employed in the first embodiment.

FIG. 3 shows the intensity variation across the calculated average intensity distribution printing the wafer when exposing it to the light-field shown in FIG. 3 when longitudinally displacing it with respect to the mask according to the prior-art teaching of DTL.

FIG. 4 shows the calculated dependencies of the peak intensity in the average distribution printing the wafer when exposing it to the light-field of FIG. 3 according to the prior-art teaching of DTL and using different displacements of the wafer during the exposure.

FIG. 5 shows the calculated dependencies of the peak values in the integrated intensity distribution printing the wafer on the mean separation of the wafer and mask for different displacements of the wafer during exposure when exposing the wafer using the first embodiment with a variation of incremental exposure dose during the displacement that corresponds to a truncated Gaussian distribution.

FIG. 6 shows the calculated dependencies of the peak values in the integrated intensity distribution printing the wafer on the mean separation of the wafer and mask for different displacements of the wafer during exposure when exposing the wafer using the first embodiment with a variation of incremental exposure dose during the displacement that corresponds to a truncated sinusoidal distribution.

FIG. 7 shows the calculated dependencies of the peak values in the integrated intensity distribution printing the wafer on the mean separation of the wafer and mask for different displacements of the wafer during exposure when exposing the wafer using the first embodiment with a variation of incremental exposure dose during the displacement that corresponds to a triangular distribution.

FIG. 8 is a schematic representation of a second embodiment of the invention for printing a periodic pattern onto a wafer by varying the intensity of a beam illuminating the mask during the longitudinal displacement of the wafer with respect to a mask.

FIG. 9 shows a computer simulation of the average intensity distribution printing a wafer using the mask pattern of the second embodiment and longitudinally displacing the wafer with respect to the mask during the exposure according to the prior-art teaching of DTL.

FIG. 10 shows the calculated dependencies of the peak intensity in the average distribution printing the wafer when exposing it to the light-field of FIG. 10 according to the prior-art teaching of DTL and using different displacements of the wafer during the exposure.

FIG. 11 shows the calculated dependencies of the peak values in the integrated intensity distribution printing the wafer on the mean separation of the wafer and mask for different displacements of the wafer during exposure when exposing the wafer using the second embodiment with a variation of incremental exposure dose during the displacement that corresponds to a truncated Gaussian distribution.

FIG. 12 shows the calculated dependencies of the peak values in the integrated intensity distribution printing the wafer on the mean separation of the wafer and mask for different displacements of the wafer during exposure when exposing the wafer using the second embodiment with a variation of incremental exposure dose during the displacement that corresponds to a truncated sinusoidal distribution.

FIG. 13 shows the calculated dependencies of the peak values in the integrated intensity distribution printing the wafer on the mean separation of the wafer and mask for different displacements of the wafer during exposure when exposing the wafer using the second embodiment with a variation of incremental exposure dose during the displacement that corresponds to a triangular distribution.

### DETAILED DESCRIPTION OF THE INVENTION

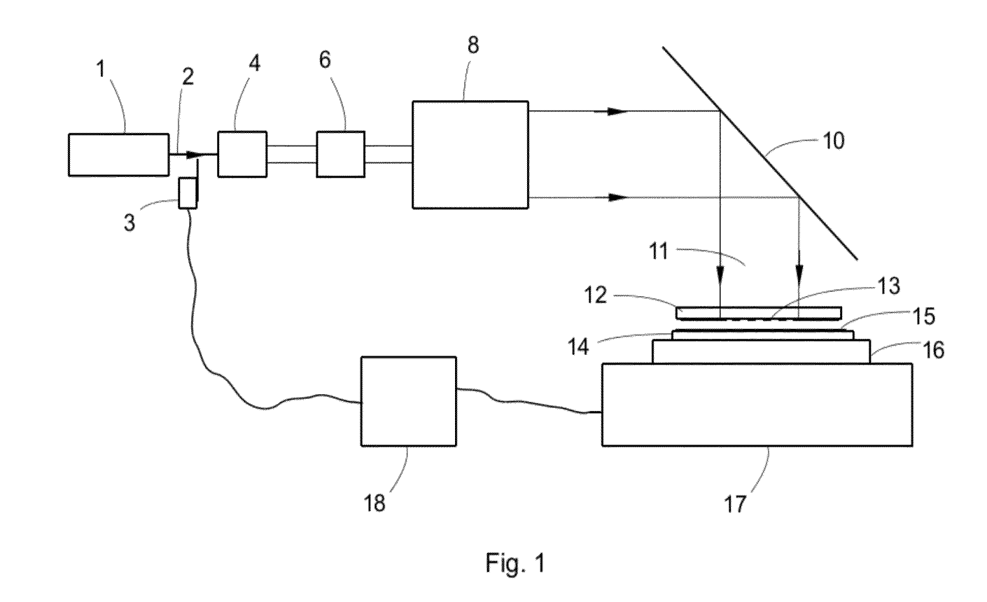

With reference to FIG. 1, which shows a first exemplary embodiment of the invention, an argon-ion laser 1 emits a beam of substantially monochromatic light 2 with a wavelength 363.8 nm and a diameter ˜2 mm, which is in single transverse mode (so has a Gaussian intensity profile) and multiple longitudinal mode. The light is plane-polarized, the polarization vector being orthogonal to the plane of the diagram. Such a laser may be obtained from, for example, Newport Corporation (in particular, their range of BeamLok lasers) or from Coherent Inc. (in particular, their range of Innova Sabre lasers). After passing through an electronically operated shutter 3 the diameter of the beam 2 is enlarged by a beam expander 4, which comprises a pair of lenses, so that the intensity profile of the resultant beam may be more easily converted, using a beam-transformer 6, from a Gaussian distribution into one that is substantially uniform across the central part of the beam. Suitable beam transformers are commercially available from, for example, Moltech GmbH (in particular, their piShaper product range). The output beam of the beam transformer 6 passes through a second beam-expander 8 that forms a collimated beam whose central, uniform part has a diameter larger than the size of the pattern to be printed. This beam is reflected by a mirror 10 to a mask 12 so that a pattern 13 in the mask 12 is uniformly illuminated by collimated beam 11 at normal incidence. On the underside surface of the mask is a one-dimensional periodic pattern 13 (i.e. linear grating) with a period of 800 nm composed of opaque lines and transparent spaces. The pattern 13 has been fabricated in a layer of chrome on a thick (e.g. 0.25″) fused silica substrate using standard electron-beam mask manufacturing technology. Whereas the figure only shows five lines and spaces in the mask pattern 13, it should be understood that many orders of magnitude more lines may be present and that the mask pattern 13 typically has dimensions measured in centimetres. The mask 12 is rigidly mounted to a support frame (not shown in the diagram).

Below the mask 12 is a wafer 14 that has been spin-coated on its upper surface with a ˜1 um-thick layer of a standard i-line sensitive photoresist 15. The wafer 14 is mounted to a vacuum chuck 16 that is attached to a mechanical positioning system 17 incorporating actuators configured for positioning the wafer 14 substantially parallel and in proximity to the pattern 13 in the mask 14. The actuators are displaced using the control system 18. The actuators preferably comprise three piezo-electric transducers (PZTs) each having an integrated strain gauge or capacitive sensor to enable closed-loop control of their respective displacements in order to minimize displacement errors caused by hysteresis and drifts, and preferably have a long travel range, such as 50 μm. Using, for example, reference spacers of known and equal thickness that are introduced on different sides of the wafer 14, the wafer 14 is adjusted parallel to the mask 12 and in proximity to the mask 12. The separation between the wafer 14 and mask 12 may be typically initially set to a value of 20 μm. As for displacement Talbot lithography, this parameter is not critical though should be small enough so that the range of angles in the illuminating beam due to non-perfect local collimation do not unacceptably degrade the resolution of the printed pattern. The positioning system 17 should most preferably also incorporate guides or an equivalent mechanism (as would be well-known to an engineer skilled in the art of standard precision positioning systems) in order that the longitudinal displacement of the wafer 14 that is required during the exposure operation is accurately orthogonal to the wafer 14 surface, to the extent that any transverse component of displacement during the exposure is small in relation to the period of the pattern being printed. The control system 18 additionally enables the wafer to be longitudinally displaced with a speed that varies during the displacement according to a predetermined profile, as is also required during the exposure operation.

Illuminating a grating pattern 13 of period 800 nm with a collimated beam 11 of wavelength 363.8 nm produces 0^{th} and 1^{st} diffraction orders which interfere to form a series of self-image planes in the transmitted light-field, whose separation, S₀₁, is given by

S₀₁=λ/(cos θ₀−cos θ₁) equ. (3)

where θ₀ and θ₁ are the angles of the 0^{th} and 1^{st} diffraction orders respectively.

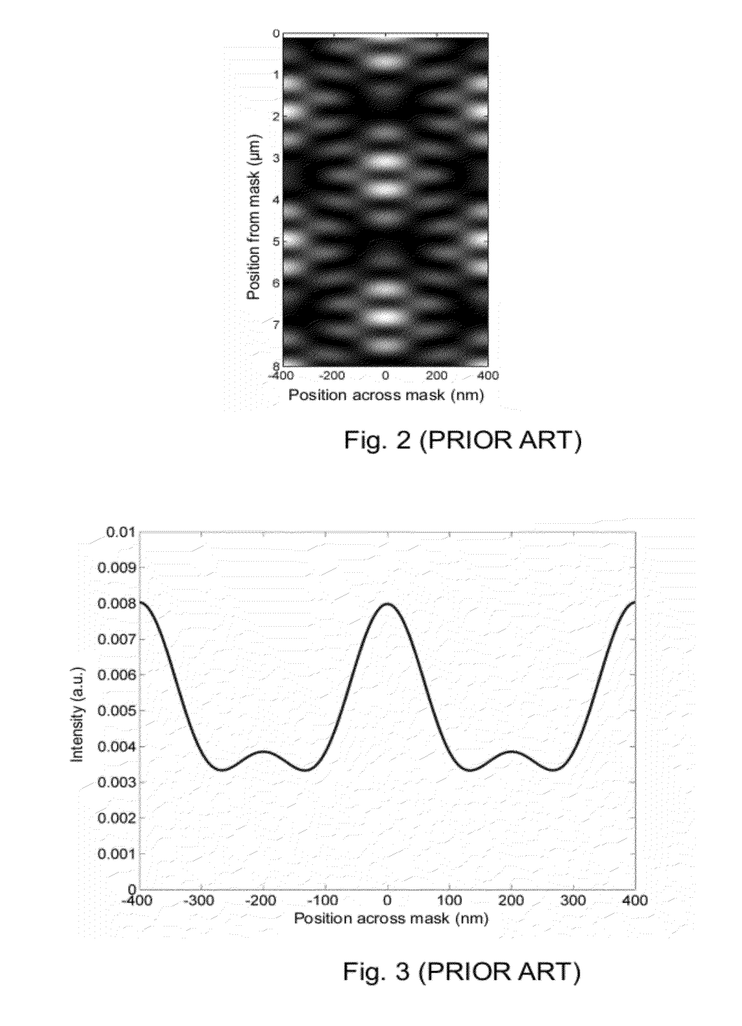

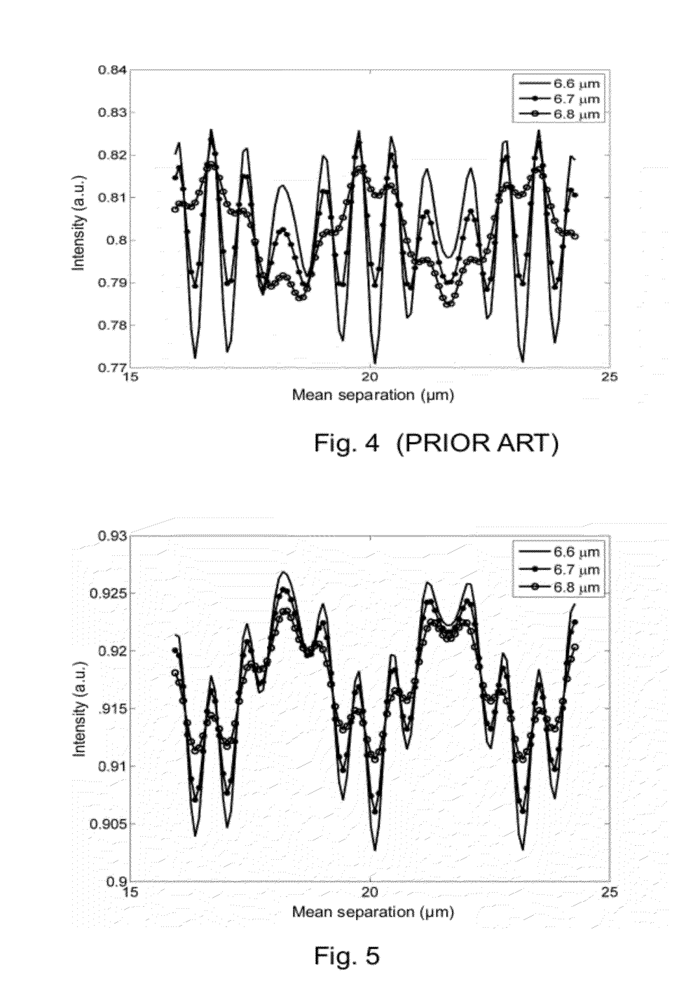

Using equ. (3), S₀₁≈3.3 μm. However, due to the high diffraction angles of the 1^{st} and 2^{nd} order beams (˜27° and ˜66° respectively), the 2^{nd} diffraction orders are not accurately in phase with the 0th- and 1^{st}-order beams in these planes, and so self-images of the mask pattern 13 are not accurately formed nor are they accurately located in distinct Talbot planes. As a result, if this mask pattern 13 were exposed at this illumination wavelength using the prior art technique of displacement Talbot lithography, it would be very difficult to print the pattern uniformly onto the wafer 14. The sensitivity of the line-width of the printed pattern to variation of the separation of the mask 12 and wafer 14 may be evaluated by computer simulation of the exposure process. Such computer simulation is preferably performed using standard theoretical methodologies, such as finite difference time domain (FTDT) or rigorous coupled wave analysis (RCWA), for calculating the propagation of electromagnetic waves through periodic micro-structures and through uniform media. Commercially or freely available software may be used, such as GSolver (in the case of RCWA, produced by the company Grating Solver Development Co.) or MEEP (in the case of FTDT, produced by Massachusetts Institute of Technology). The diffracted light-field transmitted by the mask pattern 13 employed in this embodiment illuminated at normal incidence by a beam 11 with wavelength 363.8 nm was simulated and the result is shown in FIG. 2, which shows a section of the light-field over a width of one period of the grating pattern 13 and extending up to a distance of 8 μm from the mask 12. As can be observed, at regular intervals of ˜3.3 μm self-images of the pattern 13 in the mask 12 are formed, though the intensity distribution is not exactly periodic with increasing distance because of the changing relative phase of the 2^{nd} order beams at the self-image planes. The effect of applying the DTL method to this illuminated grating 13 may be determined by integrating the light-field over a range of distances corresponding to an integer multiple of the separation of successive self-image planes. With the wafer 14 at an initial distance of 20 μm from the mask 12 and the light-field integrated over a range of twice the Talbot distance (i.e. over 6.6 μm), the average intensity distribution that exposes the photoresist 15 is a periodic pattern of bright lines whose period is half that of the pattern in the mask, as is generally obtained when applying DTL to a one-dimensional mask pattern. The intensity variation across this distribution (in the direction orthogonal to the lines) is illustrated in FIG. 3, which shows the variation over a distance corresponding to one period of the mask pattern 13. In order that the pattern can be printed uniformly and reproducibly from the mask 12 onto the wafer 14 even if they are not accurately flat or parallel, it is necessary that the intensity of the peaks in the integrated distribution are not sensitive to the initial local separation of the wafer 14 and mask 12 or sensitive to deviations of the actual displacement of the wafer from the desired value. The dependencies of the peak intensity on the initial separation and on the displacement distance may be evaluated by computer simulation. The results of such an evaluation for the illuminated pattern concerned are presented in FIG. 4, which shows the magnitude of the peak intensity peak plotted as a function of the mean separation of the wafer 14 and mask 12 for different displacement distances of the wafer 14 during the exposure. As can be seen, when the displacement distance is 6.6 μm (i.e. twice the Talbot distance), the peak intensity fluctuates strongly, up to ˜7%, with varying mean separation, whereas with displacement distances of 6.7 and 6.8 μm, the intensity fluctuations are respectively 4.5% and 4%. These results demonstrate the difficulty and limitations of applying the DTL technique using this exposure wavelength to the pattern concerned if a high-uniformity of line-width is required across the printed pattern and if high reproducibility is required between printed wafers.

In this embodiment of the invention, the wafer 14 is not displaced relative to the mask 12 at a constant speed during the exposure so that the range of intensity distributions between Talbot planes are uniformly recorded in the photoresist layer 15, but the speed of displacement is instead varied during the displacement so that the dependence of the exposure density, E, per unit incremental change in separation, d, of the wafer 14 and mask 12 corresponds substantially to a truncated Gaussian distribution represented by

E=E₀exp{−(d−d₀)²/2σ²}, with |d−d₀|≦tσ equ. (4)

where E₀ is a constant, exp{ } represents the exponential function, d₀ is the mean separation during the displacement, σ is the standard deviation of the Gaussian function described, t defines the truncation of the Gaussian function, and |x| represents the magnitude of x.

Using the apparatus of FIG. 1, this can be achieved by programming the control system 18 so that the actuators displace the wafer 14 either towards or away from the mask 12 during the exposure with a speed, v, that is inversely proportional to the exposure distribution described by equ. (4), that is:

v=kexp{(d−d₀)²/2σ²}, with |d−d₀|≦tσ equ. (5)

where k is a constant.

The function describing the position required of each actuator as a function of time may be straightforwardly mathematically derived from equ. (5).

To obtain a desirable exposure result, it is recommended that t≈2, though other values may be used depending on the particular requirements of the application with respect to, for instance, the line-width uniformity. It is further recommended that σ be selected so that it corresponds to substantially half the separation of Talbot planes, though this value may also be adjusted according to the particular requirements of the application. In order that the photoresist 15 is only exposed to the light-field transmitted by the mask 12 during the exposure defined by equ. (4) above, it is preferable that the opening and closing of the shutter 3 activated by the control system 18 at respectively the start and end of the exposure are synchronized with the displacement of the actuators. The constant, k, is simply a scaling factor which should be selected in combination with the intensity of the illuminating beam in order that the total exposure dose illuminating the layer of photoresist 15 produces a desired structure in the photoresist 15 following its development. The exposure dose is preferably optimized experimentally by printing a number of wafers with different doses and evaluating the printed results.

The effect of displacing the wafer 14 during exposure with the variable speed described by equ. (5) on the average intensity distribution exposing the photoresist 15, in particular the effect on the dependence of the peak intensity of the distribution on the mean separation of the wafer 14 and mask 12 and on the dependence of the peak intensity on deviations of the actual displacement from the desired value, may be evaluated by computer simulation. The results of such simulations for the illuminated pattern concerned for mean separations between 15 and 25 μm, for σ=1.65, 1.675 and 1.7 μm and using t=2 so that the maximum displacements of the wafer are respectively 6.6, 6.7 and 6.8 μm, are shown in FIG. 5. From the results, the fluctuations of the peak intensity with varying mean separation are determined for the three cases to be ˜2.5%, ˜2% and ˜1.5% respectively, so are significantly less than the corresponding values determined above for an exposure according to the prior-art teaching of displacement Talbot lithography, and therefore enable the one-dimensional pattern to be printed with much better uniformity and reproducibility. The residual fluctuations may be reduced further, if required, by adjusting the parameter values of the truncated Gaussian distribution.

A significant improvement to the uniformity and reproducibility of the printed pattern may be obtained using the same apparatus of this embodiment but with the control system 18 programmed to modulate the speed of displacement of the actuators during the exposure in order that the exposure energy density, E, per incremental displacement of the wafer 14 varies with the separation, d, of the wafer 14 and mask 12 according to a truncated sinusoidal function described by:

E=E₀ cos²{π(d−d₀)/2L}, with |d−d₀≦tL equ. (6)

where d₀ is the mean separation during the exposure, 2L is the period of the sinusoidal variation and t defines the truncation of the sinusoidal distribution and defines the maximum displacement of the wafer 14 during the exposure (when t=1, the function is truncated to one period of the oscillation).

The speed of displacement required of the actuators is therefore given by:

v=ksec²{π(d−d₀)/2L}, with |d−d₀≦tL equ. (7)

where k is a constant.

It is recommended that L be selected to correspond to the Talbot distance for the illuminated pattern, and that t be close to but less than 1, such as 0.9, in order to limit the maximum speed of displacement required of the actuators. With these values the resulting variation of exposure density with displacement of the wafer 14 approximates to the previous truncated Gaussian distribution. The control system 18 should preferably also automatically open and close the shutter 3 during the displacement of the actuators so that the photoresist is only exposed to the light-field transmitted by the mask during the required range of displacement; and the scaling factor, k, should be selected in combination with the intensity of the illumination beam in order that the total exposure dose illuminating the photoresist 15 produces a desired structure in the photoresist 15 following its development. The exposure dose is preferably optimized experimentally by printing a number of wafers with different doses and evaluating the printed results.

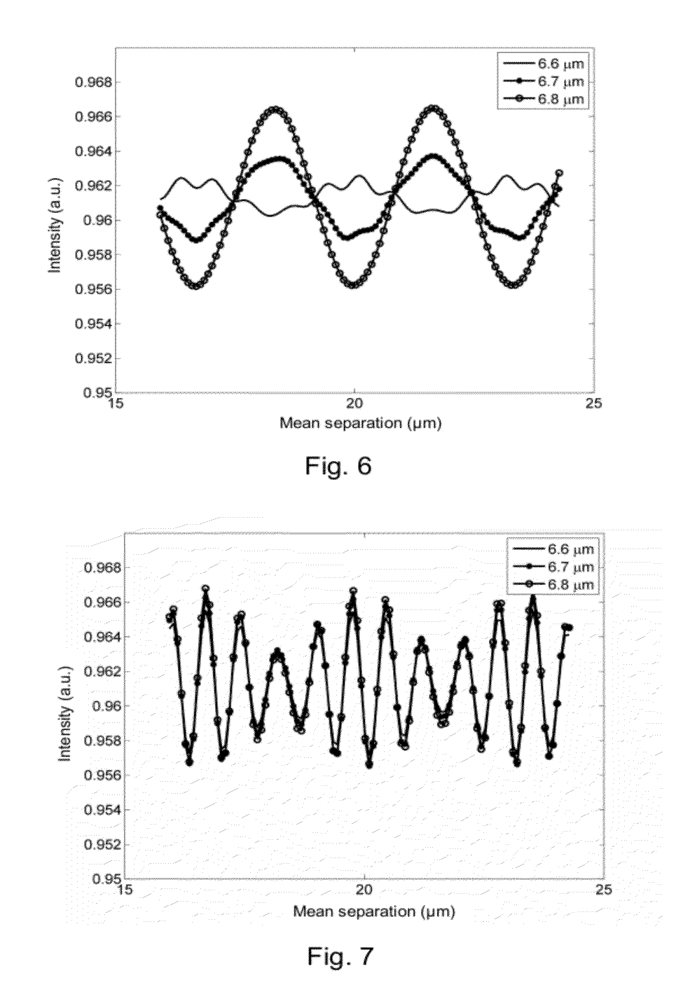

Computer simulations may be similarly performed to determine the sensitivity of the resulting integrated intensity distribution exposing the photoresist 15 to variation in the mean separation of the wafer 14 and mask 12 and to deviations of the maximum displacement of the wafer 14 from the optimum value. The results of such simulations for the illuminated pattern concerned for the cases L=3.3, 3.35 and 3.4 μm and using t=1, so that the respective maximum displacements of the wafer are respectively 6.6, 6.7 and 6.8 μm, are presented in FIG. 6. From the results, the fluctuations of the peak intensity with varying mean separation are determined for the three cases to be ˜0.03, ˜0.6 and ˜1% respectively, so are significantly less than the corresponding values determined above for an exposure according to the prior-art teaching of displacement Talbot lithography, therefore enabling the one-dimensional pattern to be printed with much better uniformity and reproducibility.

Another function that may be used for modulating the displacement of the actuators during the exposure is one that produces a truncated triangular dependence of the exposure dose per incremental change of separation on the separation, d, of the wafer 14 and mask 12 according to:

E=E₀(L−|d−d₀|), with |d−d₀|≦tL equ. (8)

where d₀ is the mean separation, 2L is the width of the (untruncated) triangular function, and t defines the truncation of the triangular function and defines the maximum displacement of the wafer 14 during the exposure.

The speed of displacement required of the actuators is therefore given by:

E=k/(L−|d−d₀|), with |d−d₀≦tL equ. (9)

where k is a constant.

It is recommended that L be selected to correspond to the Talbot distance for the illuminated pattern, and that t be close to but less than 1, such as 0.9, in order to limit the maximum speed of displacement required of the actuators. With these values the resulting variation of exposure density with displacement of the wafer 14 again approximates to the previous truncated Gaussian distribution. The control system 18 should preferably also automatically open and close the shutter 3 during the displacement of the actuators so that the photoresist 15 is only exposed to the light-field transmitted by the mask 12 during the required range of displacement; and the scaling factor, k, should be selected in combination with the intensity of the illumination beam in order that the total exposure dose illuminating the photoresist 15 produces a desired structure in the photoresist 15 following its development. The exposure dose is preferably optimized experimentally by printing a number of wafers with different doses and evaluating the printed results.

Computer simulations may be similarly performed to determine the sensitivity of the resulting integrated intensity distribution exposing the photoresist 15 to variation in the mean separation of the wafer 14 and mask 12 and to deviations of the maximum displacement of the wafer 14 from the optimum value. The results of such simulations for the illuminated pattern concerned for the cases L=3.3, 3.35 and 3.4 μm and using t=1, so that the respective maximum displacements of the wafer are respectively 6.6, 6.7 and 6.8 μm, are presented in FIG. 7. From the results, the fluctuations of the peak intensity with varying mean separation are determined for all three cases to be ˜1%, so are significantly less than the corresponding values determined above for an exposure according to the prior-art teaching of displacement Talbot lithography, therefore enabling the one-dimensional pattern to be printed with much better uniformity and reproducibility.

The dependencies of the incremental exposure density illuminating the mask 12 on the separation of the wafer 14 and mask 12 that are achieved using the truncated Gaussian, truncated sinusoidal and truncated triangular distributions are substantially the same. These profiles of dependency may be generally characterized as having a full width that approximately corresponds to twice the Talbot distance and having a full-width at half-maximum (FWHM) that approximately corresponds to the Talbot distance. It should therefore be understood from the foregoing that other dependencies of the incremental exposure density on the separation of the wafer 14 and mask 12 which may also be characterized in this way may be alternatively employed with the expectation of obtaining similar improvements in the uniformity and reproducibility of the printed patterns. Moreover, simulation results show that greater improvements in the uniformity and reproducibility of the printed patterns may be obtained by employing a variation of exposure density per incremental change of separation over the range of separation whose FWHM is twice the Talbot distance or a higher multiple thereof and whose full width is four times the Talbot distance or a higher even multiple thereof. These variations, however, require a larger displacement of the wafer 14 with respect to the mask 12, so can be undesirable.

Preferably, therefore the FWHM of the variation of the exposure density per incremental change of separation over the range of separation should be in the range 0.7-1.3 times a multiple of the Talbot distance (where multiple=1, 2, 3, . . . ), and most preferably in the range 0.9-1.1 times a multiple of the Talbot distance; and the full width of the distribution should preferably be in the range 1.5-2.5 times an even multiple of the Talbot distance and most preferably in the range 1.8-2.2 times an even multiple of the Talbot distance.

Whereas, in the above embodiment the variation of speed of displacement of the wafer 14 with respect to the mask 12 is achieved by varying the speed of displacement of the wafer 14, in other embodiments of the invention the equivalent effect and result may be achieved by alternatively varying the speed of displacement of the mask 12. In this case, a suitable mechanical system incorporating an actuator or actuators and an associated control system should be provided for longitudinally displacing the mask 12 with a variable speed during the exposure.

Whereas in the embodiments described above the displacement of the wafer relative to the mask during the exposure is in a single direction over the required range with the required variation of speed, in other embodiments of the invention multiple displacements of the wafer over the range may be alternatively performed during the exposure, wherein each displacement conforms to the teaching described above, and preferably the direction of displacement is reversed between successive displacements. It is evident that a repetition of the same motion of displacement during the exposure will result in the same printed pattern on the wafer. By using a repetition of displacement over the scan range during the exposure, the sensitivity of the printed pattern to synchronization errors between the total time of the exposure defined by the illumination system and the total time during which the wafer is displacing is reduced, so is advantageous.

In other embodiments of the invention using the same apparatus as employed in the first embodiment, or using an equivalent apparatus, the wafer is displaced relative to the mask by substantially the same maximum distance during the exposure, but using a stepping motion in which the wafer is displaced in a series of steps and with a varying delay time between steps.

By selecting the step size to be small in relation to the maximum distance of displacement and by selecting the delay time to vary according the desired variation of incremental exposure dose over the range of displacement, it will be appreciated that this exposure strategy approximates to that described in the first embodiment in which the wafer is displaced using a continuous motion and a varying speed, and so the printed results can be substantially the same.

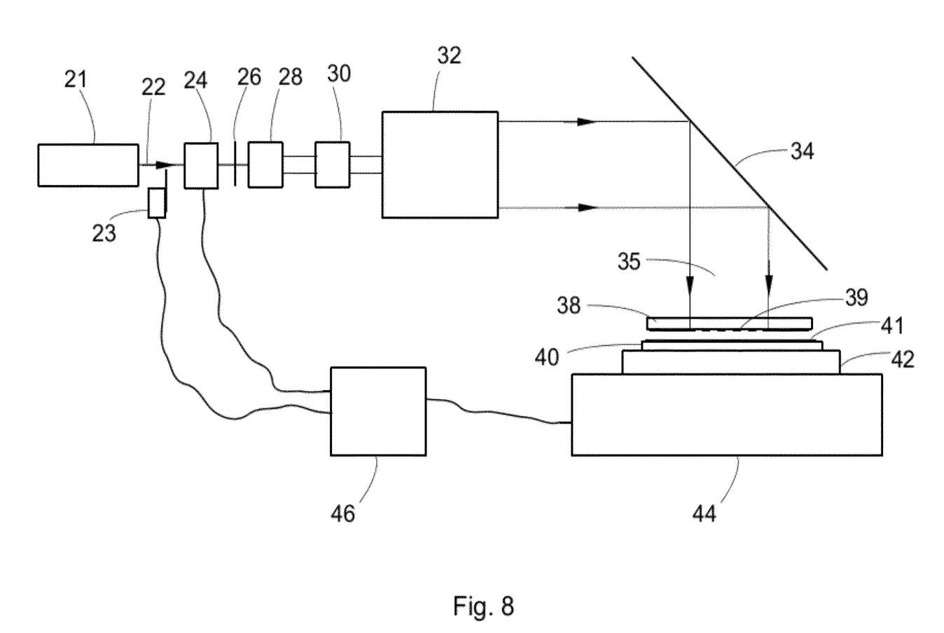

With reference to FIG. 8, which shows a second exemplary embodiment of the invention, an argon-ion laser 21 emits a beam of substantially monochromatic light 22 with a wavelength 363.8 nm, a diameter ˜2 mm, and which is in single transverse mode (so has a Gaussian intensity profile) and multiple longitudinal mode. The light is plane-polarized. After passing through an electronically operated shutter 23, the beam 22 is incident on a motorized variable attenuator 24 that is linked to a control system 46 that enables the intensity of the transmitted beam to be varied either continuously or in a stepped, quasi-continuous manner (i.e. digitized to, for example, 16 levels) during the exposure operation. Motorized variable attenuators are commercially available from such companies as Metrolux Optische Messtechnik GmbH (in particular, its range of Variable Dielectric Laser Beam Attenuators) and Del Mar Photonics Inc. (in particular, its range of Diffractive Variable Attenuators). The transmitted beam from the variable attenuator 24 is then incident on a quarter-wave plate 26 that produces a circularly polarized beam. The diameter of this beam is enlarged by a beam expander 28, which comprises a pair of lenses, so that the intensity profile of the resultant beam may be more easily converted, using a beam-transformer 30, from a Gaussian distribution into one that is substantially uniform across the central part of the beam. Suitable beam transformers are commercially available from, for example, Moltech GmbH (in particular, their piShaper product range). The output beam of the beam transformer 30 passes through a second beam-expander 32 that forms a collimated beam whose central, uniform part has a diameter larger than the size of the pattern to be printed. This beam is reflected by a mirror 34 to a mask 38 so that a pattern 39 in the mask 38 is uniformly illuminated by collimated beam 35 at normal incidence. On the underside surface of the mask is a two-dimensional periodic pattern of holes 39 in an opaque layer that are arranged on a hexagonal grid with a nearest-neighbour period of 520 nm. Whereas the figure only shows five holes in the mask pattern 13, it should be understood that many orders of magnitude more holes are present and that the mask pattern 13 typically has dimensions measured in centimetres. The pattern 39 has been formed in a layer of chrome on a thick fused silica substrate using standard electron-beam mask manufacturing technology. The mask 38 is rigidly mounted to a support frame (not shown in the diagram). Below the mask 38 is a wafer 40 that has been spin-coated with a ˜1 um-thick layer of a standard i-line-sensitive photoresist 41. The wafer 40 is mounted to a vacuum chuck 42 attached to a mechanical positioning system 44 incorporating actuators for positioning the wafer 40 substantially parallel and in proximity to the pattern 39 in the mask 38. The actuators preferably comprise 3 piezo-electric transducers (PZTs) each having an integrated strain gauge or capacitive sensor to enable closed-loop control of their respective displacements in order to minimize displacement errors caused by hysteresis and drifts, and preferably have a long travel range, such as 50 μm. The associated control system 46 for the actuators allows each to be either displaced independently or displaced in parallel with a constant speed. The actuators are configured to enable the wafer 40 to be tilted in orthogonal planes. Using also, for example, reference spacers of known and equal thickness that are introduced on different sides of the wafer 40, the wafer 40 is adjusted parallel and in proximity to the mask 38. The initial separation between the wafer 40 and mask 38 may be set typically to a value of 20 μm.

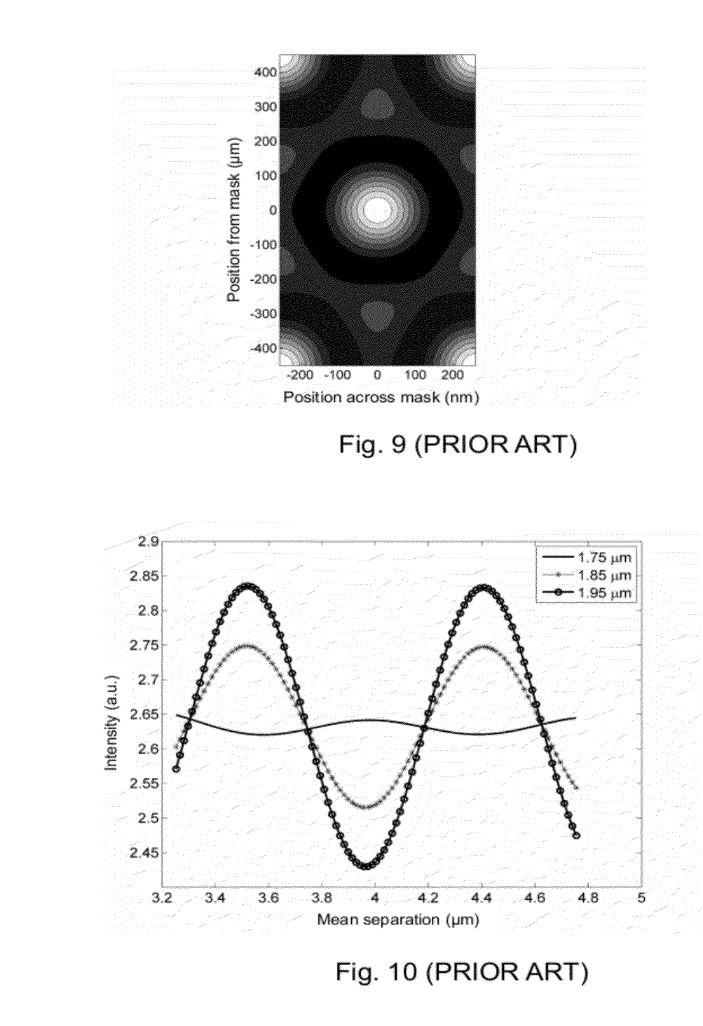

Illumination of the hexagonal pattern of features 39 in the mask 38 with light of wavelength 363.8 nm produces a transmitted light-field composed of a 0^{th}-order, undiffracted beam and six 1^{st} diffraction orders which interfere to form self-images separated by a Talbot distance of ˜0.88 μm. Since there are no 2^{nd} or higher diffraction orders, the transmitted light-field is exactly periodic in the direction orthogonal to the mask (neglecting the edges of the pattern). Since the illuminating beam 35 is circularly polarized, the components of polarization in orthogonal planes are equal, thereby enabling a symmetric distribution of the diffraction orders and symmetric features in the self-images. The average intensity distribution that would be recorded from the mask 38 onto a photoresist-coated wafer 40 using the prior-art technique of DTL, by longitudinally displacing a wafer 40 through the light-field by a distance corresponding to an integer multiple of the separation of successive Talbot planes, may be determined by computer simulation. The result is illustrated in FIG. 9, which shows a unit cell of the hexagonal array of intensity peaks whose nearest-neighbour distance is the same as the pattern 39 in the mask 38. Since the light-field after the mask 38 is exactly periodic in the direction orthogonal to the mask, the intensity of the peaks in this distribution is independent of the mean separation of the wafer 40 and mask 38 during the DTL exposure. If, on the other hand, the displacement distance is not exactly an integer multiple of the separation between Talbot planes (because of, for example, mechanical hysteresis) then the peak intensity is no longer insensitive to the mean separation. This dependence is evaluated by computer simulation for displacement distances of respectively 1.75, 1.85 and 1.95 μm, and the results are shown in FIG. 10. From the results, when the displacement is ˜0.01 μm from twice the Talbot distance, the fluctuation of peak intensity with varying mean separation is <1%, but for displacements that are only 0.09 μm and 0.19 μm from twice the Talbot distance, the peak intensities fluctuate by ˜9% and ˜16% respectively with varying mean separation, which would be unacceptably large for some applications.

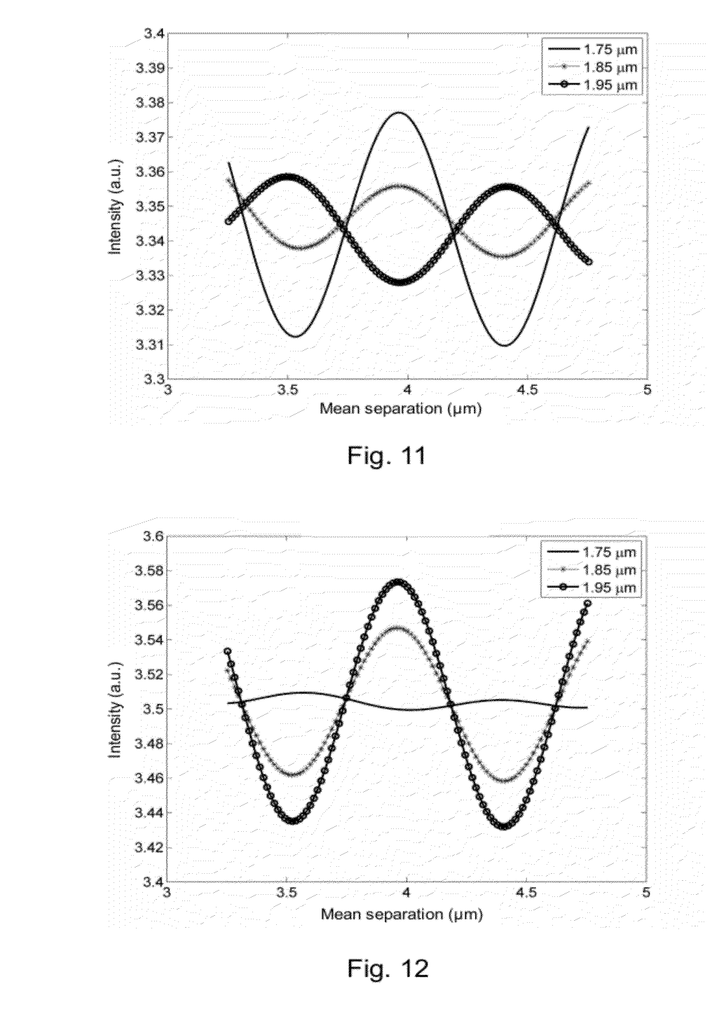

In this embodiment of the invention, the wafer 40 is longitudinally displaced relative to the mask 38 at a constant speed during the exposure in a manner according to the prior-art teaching of DTL. However, in contrast to that prior art, the intensity of the illuminating beam 35 is not constant during the exposure so as to record an average of the transversal intensity distributions between Talbot planes, but is instead varied so that the energy density of the illumination per incremental change of separation between the wafer 40 and mask 38 varies across the range of separation. The intensity of the beam 35 during the displacement of the wafer 40 is regulated by the control system 46 which adjusts the transmission of variable attenuator 24 according to a pre-programmed function representing the desired variation of energy density per incremental change of separation across the range of separation. The control system 46 preferably also opens and closes the shutter 23 at respectively the start and end of the exposure to ensure that the photoresist 41 is not otherwise exposed. Preferably, the function corresponds substantially to a truncated Gaussian distribution, as described by equ. (4). As in the first embodiment, it is recommended that the value assigned to the standard deviation of this function, σ, be half the separation of the Talbot planes in the transmitted light-field, and that the maximum displacement of the wafer 40 during the exposure be set to twice the Talbot distance (i.e. t=2), although other values may also be employed depending on the specific requirements of the application concerned. With the wafer 40 exposed to a Gaussian distribution of energy density per incremental change of separation between the mask 38 and wafer 40, the sensitivity of the integrated intensity distribution to variation in the mean separation during the exposure and to deviations of the actual displacement of the wafer from the desired value may be evaluated by computer simulations. The results of such simulations for the illuminated pattern concerned for the cases σ=0.4375, 0.4625 and 0.4875 μm and using t=2 so that the maximum displacements of the wafer are respectively 1.75, 1.85 and 1.95 μm, are shown in FIG. 11. From the results, the fluctuations of the peak intensity with varying mean separation are determined for the three cases to be ˜2, ˜0.6 and ˜0.9% respectively, so are significantly less than the corresponding values determined above for an exposure according to the prior-art teaching of displacement Talbot lithography, and therefore enable the two-dimensional pattern to be printed with much better uniformity and reproducibility.

With the apparatus of this embodiment, other profiles of intensity variation of the illuminating beam during exposure may be alternatively employed with similarly beneficial results. For example, a truncated sinusoidal profile may be employed so that the variation of the resulting exposure energy density per incremental displacement of the wafer 40 over the range of separations has a truncated sinusoidal distribution, as is described by equ. (6) for the first embodiment. As for that embodiment, it is recommended that the maximum displacement of the wafer 40 during exposure corresponds to twice the separation of the Talbot planes in the transmitted light-field. Computer simulations may be similarly performed to determine the sensitivity of the resulting integrated intensity distribution exposing the wafer 40 to variation in the mean separation of the wafer 40 and mask 38 and to deviations of the maximum displacement of the wafer 40 from the optimum value. The results of such simulations for the illuminated pattern concerned for the cases L=0.875, 0.925 and 0.975 μm and using t=1 in equ. (6), so that the maximum displacements of the wafer are respectively 1.75, 1.85 and 1.95 μm, are presented in FIG. 12. From the results, the fluctuations of the peak intensity with varying mean separation are determined to be respectively ˜0.3, ˜2.5, and ˜4%, so are significantly less than the corresponding values determined above for an exposure according to the prior-art teaching of displacement Talbot lithography, and therefore enable the two-dimensional pattern to be printed with much better uniformity and reproducibility.

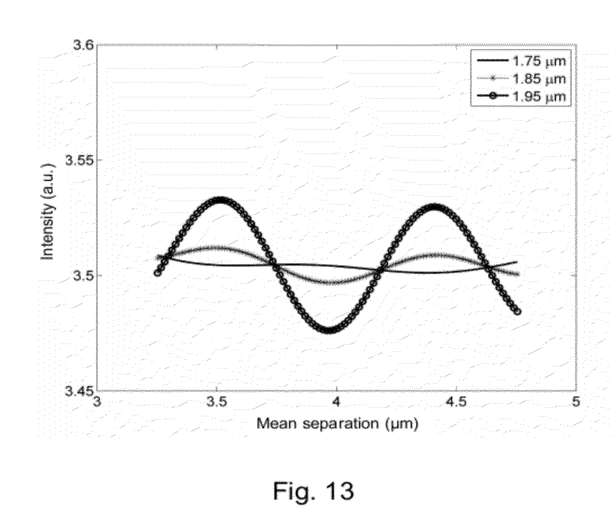

Another profile of intensity variation that may be used is a triangular variation, so that the resulting exposure energy density per incremental displacement of the wafer 40 over the range of separations has a triangular distribution, as is described by equ. (8) for the first embodiment. As for that embodiment, it is recommended that the maximum displacement of the wafer 40 during exposure corresponds to twice the separation of the Talbot planes in the transmitted light-field. Computer simulations may be similarly performed to determine the sensitivity of the resulting integrated intensity distribution exposing the wafer 40 to variation in the mean separation of the wafer 40 and mask 38 and to deviations of the maximum displacement of the wafer 40 from the optimum value. The results of such simulations for the illuminated pattern concerned for the cases L=0.875, 0.925 and 0.975 μm and using t=1 in equ. (8), so that the maximum displacements of the wafer are respectively 1.75, 1.85 and 1.95 μm, are presented in FIG. 13. From the results, the fluctuations of the peak intensity with varying mean separation are determined for the three cases to be respectively ˜0.3, ˜0.6, and ˜1.7%, so are substantially less than the corresponding values determined above for an exposure according to the prior-art teaching of displacement Talbot lithography, and therefore enable the two-dimensional pattern to be printed with much better uniformity and reproducibility.

The variations of the exposure density per incremental displacement of the wafer over the range of separations of the mask 12 and wafer 14 obtained using the truncated Gaussian, truncated sinusoidal and triangular variations of intensity of the illumination beam with the apparatus of the second embodiment described above are substantially the same. These variations may be generally characterized as having a full width that corresponds approximately to twice the Talbot distance and having a full-width at half-maximum (FWHM) that corresponds approximately to the Talbot distance. It should therefore be understood from the foregoing that other variations of incremental exposure density over the range of separations of the wafer 14 and mask 12 with the same characterizing features may be alternatively employed using the same or similar apparatus with the expectation of obtaining similar improvements in the uniformity and reproducibility of the printed patterns. Moreover, results show that greater improvements in the uniformity and reproducibility of the printed patterns may be obtained by employing a variation of exposure density per incremental change of separation over the range of separation whose FWHM is twice the Talbot distance or a higher multiple thereof and whose full width is four times the Talbot distance or a higher even multiple thereof. These variations, however, require a larger displacement of wafer 14 with respect to the mask 12, so are not necessarily desirable.

Preferably, therefore the FWHM of the variation of the exposure density per incremental change of separation over the range of separation should be in the range 0.7-1.3 times a multiple of the Talbot distance (where multiple=1, 2, 3, . . . ), and most preferably should be in the range 0.8-1.2 times a multiple of the Talbot distance; and the full width of the distribution should preferably be in the range 1.5-2.5 times an even multiple of the Talbot distance, and most preferably in the range 1.7-2.3 times an even multiple of the Talbot distance.

Whereas, the displacement of the wafer 40 with respect to the mask 38 in this second embodiment is achieved by displacing the wafer 40, in other embodiments of the invention the equivalent effect and results may be achieved by alternatively displacing the mask 38 during the exposure. In this case, a suitable mechanical system incorporating an actuator or actuators and an associated control system should be provided for longitudinally displacing the mask 38 during the exposure.

In other embodiments of the invention using the same (or equivalent) apparatus as employed in the second embodiment but without the variable attenuator 24, the wafer 40 is displaced relative to the mask 38 in the same manner during the exposure, but the illumination system instead exposes the mask 38 to a series of “sub-exposures” with a sub-exposure frequency in which the intensity is the same for all sub-exposures and the time of each sub-exposure varies over the series of sub-exposures. It can be appreciated that by employing a large number of sub-exposures and by selecting exposure times for the sub-exposures such the variation of exposure times over the series of sub-exposures corresponds to the required variation of incremental exposure density over the range of separation, then the effective exposure achieved with this strategy (in which the effective intensity of each sub-exposure is proportional to the time of the respective sub-exposure) approximates to that described in the second embodiment, and so the printed results are substantially the same. The start and end times of each sub-exposure may be defined using the shutter 23 and control system 46 of the second embodiment. The exposure time for each sub-exposure may alternatively be the same and the intensity of the illumination be varied over the number of sub-exposures according to the required variation of incremental exposure density over the range of separation.

Whereas in the above two embodiments the exposure using the variable speed of displacement of the wafer 40 is applied to a one-dimensional pattern and the exposure using a variable intensity of illumination is applied to a two dimensional pattern, in other embodiments of the invention the variable speed of displacement during exposure may, of course, equally well be applied to two-dimension patterns and the variable intensity of illumination during exposure may equally well be applied to one-dimensional patterns.

Whereas the laser source employed in both the embodiments above is an argon laser operating at a particular wavelength of 363.8 that emits a continuous-wave (CW) beam, in other embodiments of the invention alternative laser sources may be used including, for example, solid-state lasers, laser diodes, and excimer lasers, which may operate over a wide range of UV, visible and IR wavelengths, and may have a pulsed rather than CW output. Other types of light source that can provide substantially monochromatic light may be used in other embodiments, such as an arc lamp (e.g. mercury lamp) together with a filter to isolate a substantially monochromatic component.

Whereas, in both the above embodiments, a refractive beam transformer is employed as an effective means for achieving a high-uniformity and high-intensity of illumination over the mask pattern when the light source is a laser whose output beam has a Gaussian intensity profile, in other embodiments of the invention, other means may be employed for ensuring that the illumination of the pattern has high-uniformity. For example, a laser beam with a Gaussian intensity profile may be instead scanned across the pattern so that the time-integrated energy density across the pattern is uniform. In this case, the speed of displacement of the wafer or the intensity of the illumination would need to be varied in a repetitive, oscillating manner and with a sufficiently high frequency so that the exposure at each point of the mask pattern is substantially the same.

Whereas the variation of intensity in the illuminating beam in the second embodiment is produced by a variable attenuator introduced in the beam path after the laser, in other embodiments of the invention, the variation of the beam's intensity may be achieved by other means, for example, by modulating the drive current of the laser source so that the power of the output beam from the source is varied.

In other embodiments of the invention an immersion fluid such water may be included in the gap between the substrate and mask in order to reduce the smallest period of the pattern that may be printed with the technique using a particular illumination wavelength.

While the embodiments described above may be considered as preferred embodiments of the invention, it should, of course, be understood that various modifications and changes in form or detail could readily be made without departing from the spirit of the invention. It is therefore intended that the invention should not be limited to the exact forms described and illustrated, but should be constructed to cover all modifications that may fall within the scope of the appended claims.

1. A method for printing a pattern of features, including the steps of:
a) providing a substrate having a recording layer disposed thereon;
b) providing a mask bearing at least one of a periodic pattern of features and a quasi-periodic pattern of features;
c) arranging the substrate substantially parallel to the mask and with a separation having an initial value;
d) providing an illumination system for illuminating the mask with an intensity of substantially monochromatic light to generate a transmitted light-field for exposing the recording layer; and
e) illuminating the mask for an exposure time whilst changing the separation by a range having a predetermined value and varying at least one of the rate of change of separation and the intensity of the illumination so that the mask is illuminated by an energy density per incremental change of separation that varies over said range, whereby the printed pattern has low sensitivity to a deviation of the range from said predetermined value and to the initial value of the separation.

2. A method according to claim 1, wherein the variation of energy density per incremental change of separation over the range corresponds substantially to a truncated Gaussian distribution.

3. A method according to claim 1, wherein the variation of energy density per incremental change of separation over the range corresponds substantially to a truncated sinusoidal distribution.

4. A method according to claim 1, wherein the variation of energy density per incremental change of separation over the range corresponds substantially to a triangular distribution.

5. A method according to claim 1, wherein said transmitted light-field forms self-image planes separated by a Talbot distance, and the range over which the energy density per incremental change of separation is varied corresponds substantially to an even multiple of the Talbot distance.

6. A method according to claim 1, wherein said transmitted light-field forms self-image planes separated by a Talbot distance, and the full-width at half-maximum of the variation of the energy density per incremental change of separation over the range corresponds substantially to a multiple of the Talbot distance.

7. A method according to claim 1, wherein the separation is changed continuously over the range.

8. A method according to claim 1, wherein the separation is changed in a series of smaller steps over the range, the separation remaining constant for the same or different periods of time after each step.

9. A method according to claim 1, wherein the variation of energy density per incremental change of separation over the range is obtained by varying continuously the intensity of the illumination over the exposure time.

10. A method according to claim 1, wherein the variation of energy density per incremental change of separation over the range is obtained by changing the intensity of the illumination a plurality of times during the exposure time between an upper value and a lower value to form a series of sub-exposures with the upper value having a variation of sub-exposure times.

11. A method according to claim 1, wherein the separation is changed a plurality of times over said range during the exposure and at least one of the rate of change of separation and the intensity of illumination is varied during each of said changes of separation.

12. An apparatus for printing a pattern of features, which includes:
a) a substrate having a recording layer disposed thereon;
b) a mask bearing at least one of a periodic pattern of features and a quasi-periodic pattern of features;
c) a means for arranging the substrate substantially parallel to the mask and with a separation having an initial value;
d) an illumination system for illuminating the mask for an exposure time with an intensity of substantially monochromatic light to generate a transmitted light-field for exposing the recording layer;
e) a means for changing the separation over a range having a predetermined value during the illumination of the mask; and
f) a means for varying at least one of the rate of change of separation and the intensity of illumination so that the mask is illuminated by an energy density per incremental change of separation that varies over the range, whereby the printed pattern has low sensitivity to a deviation of the range from said predetermined value and to the initial value of the separation.

13. An apparatus according to claim 12, wherein the varying means includes a means for displacing at least one actuator with a variable speed.

14. An apparatus according to claim 12, wherein the illumination system includes a light source that emits a beam with an output power and the varying means changes the power of said output beam.

15. An apparatus according to claim 12, wherein the illumination system includes a variable attenuator for changing the intensity of the illumination.

16. An apparatus according to claim 12, wherein at least one of the periodic and quasi-periodic patterns of features in the mask is formed in at least one of a layer of an opaque material and a layer of a phase shifting material on a transparent substrate.

17. An apparatus according to claim 12, wherein at least one of the periodic and quasi-periodic patterns of features is periodic in a plurality of directions.

18. An apparatus according to claim 12, wherein the periodic pattern in the mask has a first period and the mask bears at least one additional periodic pattern with a different period.

19. An apparatus according to claim 12, wherein the periodic pattern in the mask has a grating vector orientated in a first direction and the mask bears at least one additional periodic pattern with a grating vector orientated in a different direction.

20. An apparatus according to claim 12, wherein the illumination system produces a beam of light and includes a scanning system for scanning said beam across the mask.
